(19) United States
(12) Patent Application Publication
(10) Pub. No.: US 2023/0115565 A1
(43) Pub. Date: Apr. 13, 2023

(54) Electrical Energy Storage Device with Adjustable Pressure on Battery Cells and Method of Operating an Electrical Energy Storage Device

(71) Applicant: Mercedes-Benz Group AG, Stuttgart (DE)

(72) Inventor: Anselm MUELBERGER, Wernau (Neckar) (DE)

(21) Appl. No.: 17/914,270

(22) PCT Filed: Feb. 19, 2021
(86) PCT No.: PCT/EP2021/054163

§ 371 Date: Sep. 23, 2022

(30) Foreign Application Priority Data
Mar. 25, 2020 (DE) 10 2020 108 136.7

(51) Int. Cl. H01M 10/04; H01M 50/211; H01M 50/264

(52) U.S. Cl. CPC H01M 10/0481; H01M 50/211; H01M 50/264; H01M 2220/20

(57) ABSTRACT

An electrical energy storage device includes a cell stack with a plurality of layers of battery cells disposed one above the other and disposed between a first pressure plate and a second pressure plate. A distance between the first pressure plate and the second pressure plate is changeable by actuation of an actuator unit. The actuator unit has a flexible envelope element which encloses the first pressure plate, the second pressure plate, and the cell stack and has a rolling element. The flexible envelope element is rollable up and unrollable by the rolling element such that the distance between the first pressure plate and the second pressure plate is changeable by a change in a length of the flexible envelope element in a peripheral direction of the flexible envelope element.

### BACKGROUND AND SUMMARY OF THE INVENTION

The invention relates to an electrical energy storage device with at least one cell stack, which comprises a plurality of layers of battery cells arranged one above the other in a stacking direction. A first pressure plate and a second pressure plate are provided to exert a pressure on the at least one cell stack arranged between the pressure plates. An actuator unit, when actuated, enables the distance between the pressure plates to be changed and a control device is used to control the actuator unit. Furthermore, the invention relates to a method for operating such an electrical energy storage device.

Electrical energy storage systems such as high-voltage batteries, for example, for vehicle applications, for example for hybrid vehicles, plug-in hybrid vehicles or electric vehicles, or high-voltage batteries for stationary applications such as electricity suppliers or storage systems have a large number of individual cells connected in series and/or in parallel. Within the high-voltage battery, the individual cells are usually grouped together in so-called cell blocks. The individual cells can be designed as so-called hardcase cells with a metallic, solid cell housing or as so-called pouch cells, which have an envelope in the form of a composite film.

The cell blocks each contain a certain number of individual cells including devices for their mechanical fixation, for electrical contacting of the individual cells and, if necessary, for temperature control, i.e., for cooling and heating. The cell block or a plurality of cell blocks are in turn housed in a closed battery housing, which in particular additionally has devices for electrically controlling and fusing the battery, such as a battery management system (BMS), contactors for switching the current, fuses, ammeters and the like on and off. Furthermore, the battery preferably contains ports to the outside, namely for the current supply and current discharge, coolant supply and coolant discharge, a port for the battery control and the like.

Mechanically fixing the stacked individual cells to form a cell block is generally done by pressing and/or gluing. Here, the axial pressing forces are applied via pressure plates arranged on the front sides of the cell block. The pressure plates are in turn connected to one another via continuous clamping means running laterally past the cell block. The clamping means can include connecting bars, tie rods, threaded bars, tension bands or similar.

The electrochemically active part of the individual cells is a so-called cell stack or electrode flat coil. The cell stack is formed by layers of cathodes and anodes as well as respective arresters, wherein the respective cathode layer is separated from the respective anode layer by a layer in the form of a separator. The cell stack is compressed perpendicularly to the layers with a certain pretensioning force to ensure its function in operation.

Above all in the case of a battery cell designed as a solid-state cell or a battery comprising a plurality of solid-state cells, an operating pressure of several bar is required for optimum functioning of the boundary layers at which the anode and the separator or the cathode and the separator abut on one another. If an anode containing lithium metal is used in the battery cell, a pressure of several bar is also required in order to optimise the so-called plating behaviour or stripping behaviour of the battery cell. During plating, metallic lithium is formed instead of lithium ions being deposited in the electrode as needed. Stripping causes the lithium anode to dissolve.

The electrochemically active electrode material inside the respective individual cell, which forms the cathode on the one hand and the anode on the other hand, changes its thickness depending on the state of charge (SOC) and the state of health (SOH). A typical value for the thickness growth when charging an individual cell designed as a solid state cell with a lithium metal anode is, for example, 15 percent when the individual cell is fully charged starting from an uncharged state (the SOC changes accordingly from 0 percent to 100 percent). A typical value for the thickness growth of the individual cell as it ages is, for example, 5 percent for both a solid-state cell and a conventional individual cell with Li-ion cell chemistry, in which the electrolyte is in liquid form. This applies to the thickness growth over the entire service life, i.e., a decrease in SOH from 100 percent to 0 percent. Considering these numerical values, a change in thickness of up to about 20 percent must therefore be compensated for overall.

In order to achieve this, elastic spring elements such as foam mats or coil springs can be arranged in the individual cells or between the individual cells.

For example, DE 10 2009 035 482 A1 describes a battery with a large number of individual battery cells, which are of flat construction and are clamped between two end plates to form a cell stack. Here, spring means can be provided as passive means for pressurising the cell stack. Furthermore, DE 10 2009 035 482 A1 proposes to arrange a controllable, e.g., electromechanical, actuator between an end plate and another end plate of the battery that is in contact with a battery housing. This active actuator can be controlled on the basis of measured values of the temperature and the pressure in the cell stack.

In the battery according to DE 10 2009 035 482 A1, the end plate can be moved by means of the electromechanical actuator relative to the further end plate, which abuts on the battery housing. Accordingly, the force applied when moving the actuator is supported against the battery housing. On the one hand, this makes it necessary to design the battery housing to be particularly robust. In addition, it thus makes it more difficult to remove a cell block comprising the end plates from the battery housing or to dismantle the cell block. The same applies if, when installing a battery in a vehicle, pressing forces are supported against structures of the vehicle. This also results in a unit that can no longer be dismantled during vehicle operation or can only be dismantled with great effort.

Another disadvantage when arranging elastic elements between the individual cells is the increase in the pressing force caused by the spring characteristic curve when the electrodes or individual cells expand. This means that the cell or cell block must be designed for very high axial forces. Furthermore, there is a travel range that cannot be used during battery operation to pretension the spring to the required minimum compression.

Moreover, an elastic element in the form of a spring has a large block length. This block length is the length of the spring in the fully compressed state. In a force-displacement diagram in which the axial compression force is indicated as a function of the distance by which the spring is compressed, the corresponding characteristic line or curve rises vertically when the block length is reached. The region from reaching this block length is thus also not usable in the operation of the battery.

The object of the present invention is to create an electrical energy storage device of the type mentioned at the start, in which an improved pressurisation of the at least one cell stack can be achieved, and to create a correspondingly improved method for operating the electrical energy storage device.

The electrical energy storage device according to the invention has at least one flexible envelope element which encloses the pressure plates and the cell stack arranged therebetween, and at least one actuated rolling element for rolling up and/or unrolling the envelope element, such that a distance between the first and second pressure plates can be changed by changing the length of the envelope element in the peripheral direction of the envelope.

In other words, the flexible envelope element, which surrounds the cell stack and defines the distance between the first and second printing plates by the envelope, can be rolled up and/or unrolled by the rolling element. In particular, the rolling element is designed to roll up and/or unroll the envelope element. By rolling up and/or unrolling, the length of the envelope element is changed in the peripheral direction. The peripheral direction or the periphery extends between the pressure plates and along the first and second pressure plates. The peripheral direction extends in parallel to the part of the envelope element which encloses the cell stack and the pressure plates.

The envelope element can have two parts: on the one hand the first part, which encloses the cell stack and the printing plates, and on the other hand the second part, which is rolled up by the rolling element. The rolling up and/or unrolling results in a shifting of these parts. When the periphery of the envelope element around the pressure plates and the cell stack becomes smaller (for example by rolling up a part of the envelope element), this results in a reduction of the distance between the first and second pressure plates. This can result in an increase in pressure on the cell stack. When the periphery of the envelope element around the pressure plates and the cell stack increases (for example, by unrolling a part of the envelope element), this results in an increase in the distance between the first and second pressure plates. This can result in a reduction of the pressure on the cell stack. Mathematically, the envelope element can be shaped according to a closed curve around the pressure plates and the cell stack. In particular, the envelope element is under tension along the closed curve, resulting in a force in the peripheral direction of the envelope element.

The first and second pressure plates can thus be actively moved towards or away from each other by the control device controlling the at least one rolling element. The rolling element can have an actuator or an electric engine that provides a force for rolling up and/or unrolling. All forces resulting from the pressure are absorbed by the envelope element and the rolling element. This means that no pressure forces have to be supported by surrounding elements. For this reason, the pressurisation of the at least one cell stack is improved. Modules or units formed by the electrical energy storage device can thus be installed particularly easily, for example in a battery housing or in a vehicle. This is because compressive forces do not need to be supported on elements such as the battery housing or the vehicle. This facilitates, for example, maintenance or replacement of a module in the form of the electrical energy storage unit.

Preferably, the control device is designed to cause a substantially constant force to be applied to the at least one cell stack by means of the at least one rolling element or by rolling up the envelope element over the pressure plates, depending on a respective thickness of the at least one cell stack.

To compensate for changes in thickness of the at least one cell stack, an actively controlled constant force system is thus preferably used, which is characterized in particular by a substantially horizontal force-displacement characteristic curve. The latter means that in the usable partial region of the path or the section in which at least one of the pressure plates is movable in relation to the other pressure plate, the force exerted by the pressure plates on the at least one cell stack is independent of the position of the movable pressure plate along the path. Along the path or track, the movable pressure plate can be advanced or retracted in parallel to the stacking direction by means of the at least one rolling element or by rolling up the envelope element, respectively. Accordingly, along the path or the track, the pressure plates can be moved towards or away from each other in parallel to the stacking direction.

If the thickness of the at least one cell stack changes, for example due to charging or discharging or also as a result of ageing, the pressure plates lying flat against the at least one cell stack are actively moved towards or away from one another according to the change in thickness, i.e., by means of the at least one rolling element or by rolling up the enclosure element. However, there is a constant axial compression in the stack direction. The force with which the pressure plates act on the at least one cell stack and thus also the pressure acting on the at least one cell stack thus remains at least substantially constant. This is also conducive to improved pressurisation of the cell stack.

Moreover, in contrast to situations when conventional spring elements are used, which can apply pressure to a cell stack, no path is lost due to the pretensioning of a spring or the spring element, which must be provided in order to achieve the required minimum compression. Instead, due to the preferably horizontal force-displacement characteristic curve of the constant force system, only the necessary minimum pretensioning force is preferably always applied. As a result, a battery cell comprising the at least one cell stack and/or a cell block comprising a plurality of battery cells can be designed to be particularly light and cost-effective and also particularly compact with regard to the installation space required.

Since the at least one cell stack is thus always compressed with the optimum force, there is also no negative influence on the performance of the battery cell or battery cells and the service life of the battery cell or battery cells.

The at least one envelope element may be a band, a rope or a chain. In other words, the at least one envelope element can be designed as a band, rope or chain. The band, rope or chain is guided around the two pressure plates with the cell stack between them. In other words, the tape, rope or chain encloses the two pressure plates with the intervening cell stack. Both ends of the rope, the tape or the chain may converge on the roller element or the roller, respectively, and/or be attached to the roller element or the roller, respectively. Alternatively, the rope, belt or chain can be guided endlessly. In this case, the roller element or the roller can engage in the endless course of the rope, the belt or the chain in order to perform the winding or unwinding. A belt, a rope or a chain can ensure a particularly stable and easily rollable enclosure of the pressure plates and the cell stack.

According to a development, it is provided that the at least one rolling element has a roller to which the enclosure element is attached. For example, the roller can be a cylinder on which the second part of the envelope element, which is rolled up by the roller element, is rolled up. Both ends of the envelope element, in particular the rope, tape or chain, may be attached to the roller. In this way, the envelope element mathematically describes a closed curve, wherein the curve is closed by the attachment to the roller. This represents a particularly effective way of manufacturing the envelope element.

According to a development, it is provided that the at least one rolling element is designed to perform the rolling up and/or unrolling of the envelope element by a rotation of the roller. By rotating the roller or the cylinder in one direction, the enclosure element can be rolled up further and by rotating it in the opposite direction, the envelope element can be unrolled. Thus, rotation of the cylinder will shorten or lengthen the first portion of the envelope element, such that the periphery of the envelope element around the first and second pressure plates and the cell stack is altered. This results in a change in the distance between the first and second pressure plates. For example, the actuator or the electric motor of the roller element is designed to rotate the roller. A roller is a particularly useful bearing for rolling up the envelope element.

According to a development, it is provided that the at least one rolling element or the roller and/or a guide shaft of the rolling element runs in parallel to the first pressure plate and/or t second pressure plate. For example, it is provided that the at least one rolling element or the roller runs in parallel to the first pressure plate and/or the second pressure plate. In other words, the rolling element or roller can be aligned in parallel to the first and/or second pressure plate. This represents a particularly space-saving and efficient spatial design.

Alternatively or additionally, it is provided that the actuator unit has at least one guide shaft, which runs in particular in parallel to the first pressure plate and/or second pressure plate. Optionally, the rolling element thus has a guide shaft. The guide shaft can again optionally be aligned in parallel to the first and/or second pressure plate. The guide shaft can ensure a particularly complete enclosure of the pressure plates as well as of the cell stack, a particularly advantageously aligned introduction of forces both into the pressure plate and into the envelope element as well as an optimal guidance of the envelope element towards the rotation element.

According to a development, it is provided that the rolling element is arranged on a side of the first or second pressure plate facing away from the cell stack. In other words, the rolling element can be arranged on an outer side of the first or second pressure plate. The outer side is in particular the side of the corresponding plate whose surface normal is perpendicular to the stacking direction of the cell stack and not adjacent to the cell stack or facing away from it. The roller element is attached to the first or second pressure plate in a particularly stable manner. Alternatively, however, it would also be conceivable to have a rolling element that is arranged neither on one of the pressure plates nor on the cell stack. For example, the rolling element can be attached exclusively to the envelope element.

According to a development, the electrical energy storage device has a further pressure plate between the first pressure plate and the envelope element as well as a further actuator which is arranged between the first pressure plate and the further pressure plate. The further actuator is designed to change a distance between the first pressure plate and the further pressure plate. By changing the distance between the further pressure plate and the first pressure plate, the distance between the first pressure plate and the second pressure plate can be changed. In other words, changing the distance between the first pressure plate and the further pressure plate can result in an opposite change in the distance between the first pressure plate and the second pressure plate. Thus, the pressure on the cell stack can be changed by the further actuator. In this case, the further pressure plate is also enclosed by the envelope element. In this way, the envelope element represents a counter bearing for the movement of the further actuator. In particular, the rolling element can also be dispensed with in the case of the further actuator. In other words, the present application also claims electrical energy storage devices having at least one envelope element, the further pressure plate (between the first pressure plate and the envelope element) and the further actuator (between the first pressure plate and the further pressure plate). If no rolling element is present, the envelope element in particular has a constant length in the peripheral direction or a constant periphery around all pressure plates. In particular, the present application therefore also claims electrical energy storage devices which comprise at least one envelope element, the further pressure plate (between the first pressure plate and the envelope element) and the further actuator (between the first pressure plate and the further pressure plate) but not a rolling element. This represents another, continuous possibility of bracing the electrical energy storage device in itself by means of the envelope element.

In a further embodiment, a further pressure plate can additionally be provided between the second pressure plate and the envelope element, wherein the distance between the second pressure plate and the further pressure plate can also be changed by means of a further actuator. In this case, there is in particular a symmetrical structure of the electrical energy storage device with respect to an axis of symmetry which runs in parallel to at least one of the pressure plates, preferably all pressure plates.

According to a development, it is provided that the further actuator comprises a toothed rack, a threaded spindle, a lever system, a toggle lever mechanism and/or a ramp mechanism. In other words, changing the distance between the first pressure plate and the further pressure plate can be done by moving the toothed rack, the lever system, the toggle lever mechanism and/or as a ramp mechanism. This represents a technically particularly efficient solution.

According to a development, it is provided that an actuator of the rolling element and/or the further actuator is designed to be self-locking and/or is designed in such a way that locking takes place in the de-energized state. In other words, the actuator of the rolling element and/or the further actuator is designed in such a way that it only performs a movement in response to a corresponding control by the control device. In the de-energized state or while there is no such control, a movement of the actuator and thus a change in the distance between the first and second pressure plates is inhibited by the self-locking or locking mechanism. In this way, electrical energy can be saved for operating the respective actuator.

In the method according to the invention for operating an electrical energy storage device with at least one cell stack comprising a plurality of layers of battery cells arranged one above the other in a stacking direction, a first pressure plate and a second pressure plate exert a pressure on the at least one cell stack arranged between the pressure plates. A control device controls an actuator unit, wherein the at least one actuator unit changes a distance between the pressure plates. In this case, the actuator unit has at least one flexible envelope element which encloses the pressure plates and the stack of cells arranged between them. At least one rolling element of the actuator unit rolls the envelope element up or down, such that a distance between the first and second pressure plates is changed by a change in length of the envelope element in the peripheral direction of the envelope. Thus, the pressure exerted on the at least one cell stack can be adjusted, in particular regulated or readjusted. Consequently, a method is created by means of which an improved pressurisation of the at least one cell stack can be achieved.

This is particularly true if the pressure exerted by the first and second pressure plates on the at least one cell stack is kept at least substantially constant by controlling the at least one actuator.

The advantages and preferred embodiments described for the electrical energy storage device according to the invention also apply to the method according to the invention and vice versa.

Further advantages, features and details of the invention emerge from the following description of preferred exemplary embodiments and from the drawings. The features and combinations of features mentioned above in the description as well as the features and combinations of features mentioned below in the description of the figures and/or only shown in the figures can be used not only in the respectively specified combination, but also in other combinations or on their own, without leaving the scope of the invention.

### BRIEF DESCRIPTION OF THE DRAWINGS

FIG. 1 shows a graph in which force-displacement characteristic curves are depicted by means of curves in a constant force system of an electrical energy storage device and in an electric energy storage device having elastic elements;

FIG. 2, in a schematic perspective view, shows a battery having a plurality of battery cells, which are tensioned between two pressure plates, wherein a distance of the pressure plates from each other can be changed by controlling a roller element, which rolls up/unrolls an envelope element comprising the pressure plates;

FIG. 3 shows the same battery of FIG. 2 in a schematic side view; and

FIG. 4 shows an alternative embodiment of a battery with additional pressure plates, which are held by an envelope element and serve as a counter bearing for respective actuators.

### DETAILED DESCRIPTION OF THE DRAWINGS

In the Figures, the same or functionally identical elements are provided with the same reference numerals.

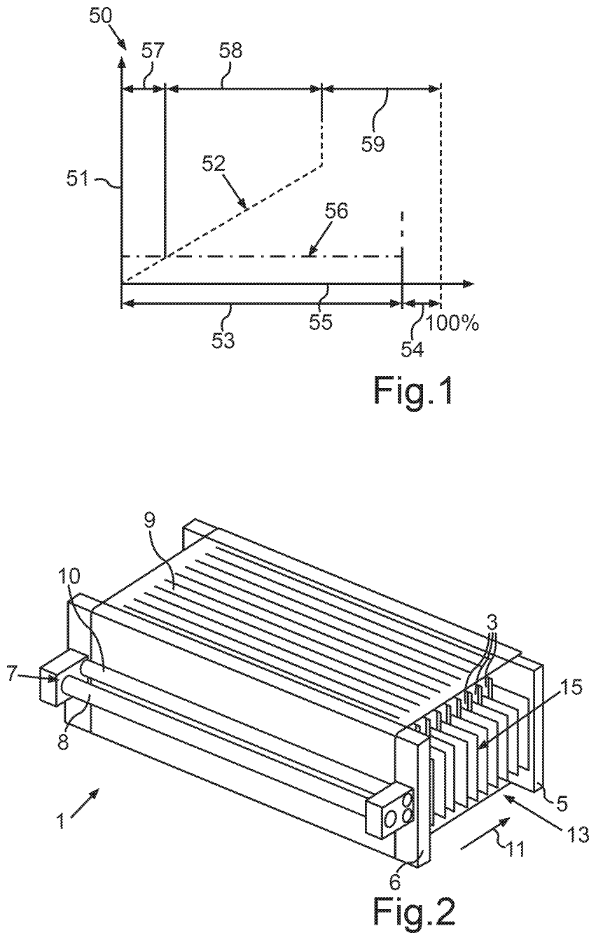

In a graph 50 shown in FIG. 1, an axial pressing force is plotted on an ordinate 51, which pressing force can be applied to battery cells 3 that are connected in a stacking direction 11 to form a cell stack 13 or battery cells 3 of a battery 1. The pressing together of electrodes in the form of cathodes and anodes of the individual battery cells 3 serves to ensure the function of the battery cells 3 of the cell stack 13 or of the battery 1.

A first characteristic curve 52 shown in the graph 50 in FIG. 1 illustrates the behaviour of an elastic element, such as a spring, which can be arranged in a cell housing of the battery cell 3 or a (not shown) battery housing of the battery 1 (c.f. FIG. 2) in order to apply a pressure to the cell stack(s) 13. In the graph 50 in FIG. 1, the distance by which the spring can be compressed is plotted on an abscissa 55. A first section 57 of the characteristic curve 52 accordingly represents a range of the distance by which the spring must be compressed in order to apply a required pretensioning force. This pretensioning force is set during assembly of the battery cell 3 or battery 1 or such a cell block. In this range of the distance, the force that can be applied by the spring cannot be used. In contrast, a further section 58 of the characteristic curve 52 represents a usable range of the distance. In this section 58, the elastic element in the form of the spring applies an increasingly greater axial pressing force to the at least one cell stack 13. The force increases (linearly) in this section 58 the further the spring is compressed.

If the spring is fully compressed, the characteristic curve 52 rises vertically. A corresponding section 59 of the distance available in the battery cell 3 or battery 1 represents a block length of the spring. If the spring is fully compressed, the electrodes of the cell stack 13 cannot expand further perpendicularly to their stack direction 11, which is illustrated by an arrow in FIG. 2.

The disadvantage of using a spring or such an elastic element, the behaviour of which is described by the characteristic curve 52 in the graph 50, is thus the increase in the pressing force caused by the spring characteristic curve when the electrodes of the at least one cell stack 13 expand. Accordingly, the battery cell 3 or the battery 1 or the cell block must be designed for very high axial forces.

This is avoided in the present case by the electrical energy storage device described in detail below in the form of a single battery cell 3 or the battery 1 (c.f. FIG. 2) having a constant force system which, according to FIG. 2, has, for example, an activated roller element 7 and an envelope element 9. The envelope element 9 encloses both pressure plates 5, 6 and the battery cells 3 of the battery 1. The envelope element 9 is designed as a flexible band. For example, the envelope element 9 can be made of textile materials and/or plastic. The roller element 7 has a roller 8 on which the envelope element 9 can be rolled up and/or unrolled.

The rolling element 7 has a drive 12, in particular an actuator or electric engine, for rotating the roller 8. In other words, the drive 12 is designed to rotate the roller 8 in order to roll up and/or unroll the envelope element 9 on the roller 8. Rolling up the envelope element 9 results in a reduction of the periphery of the part of the envelope element 9 which encloses the pressure plates 5, 6 and the cell stack 13 or the battery cells 3. Unrolling the envelope element 9 increases the periphery of the part of the envelope element 9 which encloses the pressure plates 5, 6 and the cell stack 13 or the battery cells 3. Since the pressure plates 5, 6 are at least substantially incompressible, the unrolling of the envelope element 9 results in an increase in the distance between the pressure plates 5, 6. Similarly, the rolling up of the envelope element 9 results in a reduction in the distance between the pressure plates 5, 6. An increase/decrease in the distance logically results in a reduction/increase in the pressure exerted by the pressure plates 5, 6 on the battery cells 3 or the cell stack 13. Thus, the rolling element 7 in conjunction with the envelope element 9 enables a regulation of the pressure acting on the cell stack 13 or the battery cells 3. In particular, the system made up of the rolling element 7, the envelope element 9 and the drive 12 enables the cell stack 13 or battery cells 3 to be operated with constant force and/or constant pressure on the cell stack 13 or battery cells 3. For this reason, this can be referred to as a constant force system. For improved guidance of the envelope element 9 on the roller 8, the rolling element 7 in the present case additionally has two guide rollers 10. The movement of the rolling element 7 or the drive 12 is controlled by a control device. This is done, for example, according to a characteristic curve or map stored in the control device.

A characteristic curve 56 illustrating this constant force system is also shown in the graph 50 in FIG. 1. A first, horizontal section 53 of the characteristic curve 56 represents the useable range of the path along which the pressure plates 5, 6 can be moved towards or away from each other. From the horizontal course of the characteristic curve 56 in the section 53 it can be seen that the pressure plates 5, 6 in the constant force system apply the constant force to the cell stack 13 independently of the path. This applies when applying the force to the battery cells 3 having the respective cell stacks 13, which are arranged in the pack or cell stack 13 of the battery 1 (c.f. FIG. 2), and in an analogous manner also when applying the force to the cell stack 13 arranged in a cell housing of an individual battery cell 3, if this is arranged between the pressure plates 5, 6.

Only in a very short end section 54 of the path, which corresponds to the movement space available in the battery cell 3 or the battery 1 for at least one of the pressure plates 5, 6, can the pressure plates 5, 6 not be moved further towards each other. This can be the case, for example, if the distance between the pressure plates 5, 6 and the cell stack 13 has already been maximised (for example, if the envelope element 9 has been completely unrolled) or if the rolling element 7 designed as a movement device or its drive 12 does not allow the distance to be increased further.

Accordingly, when the constant force system goes into block, the characteristic curve 56 rises vertically. However, the block length or the unusable path is significantly shorter than in the system illustrated by the characteristic curve 52, in which the spring is used. This can be clearly seen in the graph 50 from the shorter length of the end section 54 compared to the section 59. Furthermore, it can be seen from FIG. 1 that the area of the path that cannot be used when using the spring, which corresponds to the length of the section 57, can also be used when using the constant force system.

The use of the constant force system thus ensures that, when the thickness of the cell stack 13 in the battery 1 changes or when the thickness of individual battery cells 3 of the cell stack 13 changes, at least one of the pressure plates 5, 6 lying flat against the cell stack 13 is actively moved forwards, i.e., approximately against the stacking direction 11, or backwards, i.e., in the stacking direction 11, in accordance with the change in thickness. Accordingly, there is a constant axial compression of the at least one cell stack 13 of the battery 1.

The change in the thickness of the battery cells 3 of the cell stack 13 in the battery 1 can be caused by charging the battery cell 3 or the battery cells 3 or discharging them. Furthermore, as a result of ageing of the battery cells 3, the thickness of the cell stack of the battery cells 3 increases in the stacking direction 11. However, all these changes in thickness can be compensated for by the actively controlled constant force system with the preferably horizontal force-displacement characteristic, i.e., characteristic curve 56.

The use of the constant force system is particularly advantageous when the battery cells 3 are formed as solid body cells, which are designed as lithium ion cells in terms of cell chemistry. Accordingly, the positive electrode of the respective battery cell 3 can be provided by lithium compounds.

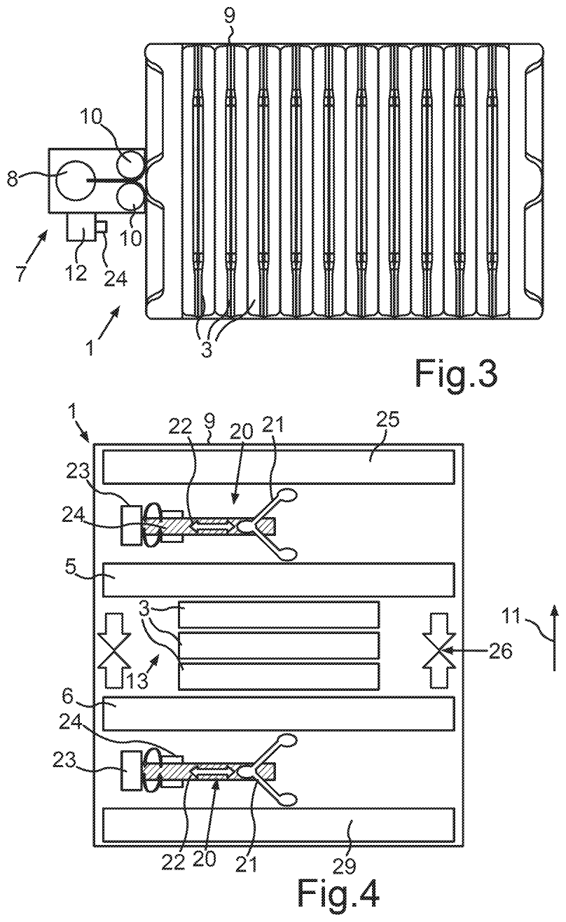

According to FIG. 2 and FIG. 3, the battery cells 3 can be designed as so-called pouch cells, in which the battery cells 3 have a flexible cover formed from a film material. This flexible cover is enclosed by a respective cell frame of the battery cell 3. Furthermore, the respective battery cell 3 has arrester lugs 15, through which electrical connections of the respective battery cell 3 are provided.

Depending on how these arrester lugs 15 in the form of a respective negative terminal and a respective positive terminal of the battery cells 3 are interconnected, a desired nominal voltage and/or a desired current intensity can be provided by the battery 1, which is preferably greater than the nominal voltage or current intensity that can be provided by a single one of the battery cells 3. In particular, the battery 1 can be designed as a high-voltage battery or as a battery module or cell block of a high-voltage battery for a motor vehicle. Such a high-voltage battery can provide a nominal voltage of more than 60 volts, in particular of several 100 volts, for example 400 volts or 800 volts.

An alternative embodiment is shown in FIG. 4. Here too, the pressure plates 5, 6 adjacent to the cell stack 13 and the cell stack 13 consisting of several battery cells 3 are enclosed by an envelope element 9. In addition, in the embodiment according to FIG. 4, two further pressure plates 25 are enclosed by the envelope element 9. A respective actuator unit 20 is arranged between a respective further pressure plate 25 and the respective adjacent pressure plate 5, 6. In the present example, the actuator unit 20 has an actuator 23 for generating a driving force, a threaded spindle 22 for transmitting the generated driving force and a toggle mechanism 21 for translating the generated force. Alternatively, embodiments with a rack and pinion drive for power transmission or a ramp system for transmission are also possible. The actuator 23 may, for example, be designed as an electric engine. The envelope element 9 can, for example, be designed as a belt, rope or chain. In a further embodiment, several similar envelope elements 9 can be provided, which is preferable in particular in the case of ropes or chains.

By controlling the actuator 23, the toggle lever mechanism 21 enables the distance between the pressure plate 5, 6 adjacent to the respective actuator unit 20 and the further pressure plate 25 adjacent to the respective actuator unit 20 to be increased and/or decreased. In other words, the respective actuator unit 20 enables the distance between the two pressure plates 5, 6, 25 adjacent to the actuator unit 20 to be changed. This change in the distance results in an increase or decrease in the force or pressure on the pressure plates 5, 6 adjacent to the respective actuator unit 20. This pressure on the respective pressure plates 5, 6 is transmitted to the battery cells 3 or the cell stack 13. Here, the actuator unit 20 generates a counterforce of equal but opposite magnitude on the adjacent further pressure plate 25. The envelope element 9 serves as an abutment for the forces acting on the further pressure plates 25. Thus, the envelope element 9 ensures that the counterforce generated by the actuator unit 20 is absorbed. Thus, the envelope element 9, which preferably does not expand significantly or only to an extremely small extent as a result of the counterforce, ensures that the force of the actuator unit 20 is focused on the battery cells 3 or the cell stack 13. Overall, the respective actuator unit 20 is designed to exert a force in the direction of the pressure plates 5, 6 by interacting with the respective adjacent pressure plate 25. This force acts in particular in parallel to the stacking direction 11.

In the present example, the battery 1 has a symmetrical arrangement of further pressure plates 25 and actuator unit 20. Of course, an asymmetrical arrangement is also possible. In such an asymmetrical arrangement, the battery has only one further pressure plate 25 and one actuator unit 20. In other words, an actuator unit 20 and an adjoining further pressure plate 25 are arranged adjacent to only one of the pressure plates 5, 6. In this case, the overall design is more compact and costs are reduced due to the omission of an actuator unit 20.

Of course, a combination of the constant force systems from FIGS. 2 and 4 is possible. The constant force systems are based on the common idea of the flexible envelope element 9. In a combination of both constant force systems, the battery 1 can have one or more actuator units 20 and a rolling element 7.

So that no holding energy needs to be applied, in variants in which the threaded spindle 22 is used, the threaded spindle 22 is preferably designed to be self-locking. This can be realised, for example, by a corresponding mechanism in a spindle nut 24, which serves in particular to guide the threaded spindle 22. In variants with the (not shown) toothed rack, a currentless active locking or brake or braking device is preferably provided. Similarly, the roller element 7 can be designed to be self-locking. For example, the roller 8 is locked or actively locked in the de-energized state of the drive 12. In this way, rolling of the roller 8 can be prevented without having to use electrical energy for this.

In order to prevent constant readjustment of the system such as the constant force system exemplarily shown in FIGS. 2 and 3 or FIG. 4, it may be useful to arrange an elastic element such as a thin tension mat between the cell stack 13 and at least one of the pressure plates 5, 6.

The constant force system can be installed once in a single battery cell 3 or once in the battery 1. However, it is also possible to install the constant force system several times in a single battery 1 or in a cell stack 13. If, for example, in a cell stack 13 with several battery cells 3, a separate constant force system with the two pressure plates 5, 6 is allocated to each individual battery cell 3, then the battery cells 3 remain in their axial position, i.e., at a constant position in relation to the stacking direction 11, despite their change in thickness. This advantageously results in a constant and equal grid dimension.

All the systems described above, which comprise the two pressure plates 5, 6 that can be moved towards and away from each other, have the advantage that they are inherently braced systems. The envelope element 9 serves as an abutment. In particular, the envelope element 9 shields forces acting outwards such that it is not necessary to support the pressure plates 5, 6 on a battery housing of the battery once. Accordingly, modules or units comprising the pressure plates 5, 6 and at least one battery cell 3 arranged between the pressure plates 5, 6 or the cell stack 13 arranged between the pressure plates 5, 6 can be installed particularly easily in the battery housing or in a vehicle. This is because the pressure forces do not need to be supported on surrounding elements such as the battery housing or the vehicle. This facilitates the replacement of such a module in particular.

### LIST OF REFERENCE CHARACTERS

1 Battery
3 Battery cell
5 Pressure plate
6 Pressure plate
7 Roller element
8 Roller
9 Envelope element
10 Guidance rollers
11 Stacking direction
12 Drive
13 Cell stack
15 Arrester lugs
20 Actuator unit
21 Toggle lever mechanism
22 Threaded spindle
23 Actuator
24 Spindle nut
25 Further pressure plate
50 Graph
51 Ordinate
52 Characteristic curve
53 Portion
54 End portion
55 Abscissa
56 Characteristic curve
57 Portion
58 Portion
59 Portion

1-10. (canceled)

11. An electrical energy storage device, comprising:
a cell stack which comprises a plurality of layers of battery cells disposed one above the other in a stacking direction;
a first pressure plate;
a second pressure plate;
wherein the cell stack is disposed between the first pressure plate and the second pressure plate; and
a first actuator unit, wherein a distance between the first pressure plate and the second pressure plate is changeable by actuation of the first actuator unit;
wherein the first actuator unit has:
a flexible envelope element which encloses the first pressure plate, the second pressure plate, and the cell stack; and
a rolling element, wherein the flexible envelope element is rollable up and unrollable by the rolling element such that the distance between the first pressure plate and the second pressure plate is changeable by a change in a length of the flexible envelope element in a peripheral direction of the flexible envelope element.

12. The electrical energy storage device according to claim 11, wherein the envelope element is a band, a rope, or a chain.

13. The electrical energy storage device according to claim 11, wherein the rolling element has a roller and wherein the flexible envelope element is fixed to the roller.

14. The electrical energy storage device according to claim 13, wherein the flexible envelope element is rollable up and unrollable by the rolling element by rotating the roller.

15. The electrical energy storage device according to claim 13, wherein the rolling element or the roller of the rolling element or a guide shaft of the rolling element runs in parallel to the first pressure plate and the second pressure plate.

16. The electrical energy storage device according to claim 11, wherein the rolling element is disposed on a side of one of the first pressure plate and the second pressure plate and faces away from the cell stack.

17. The electrical energy storage device according to claim 11, further comprising:
a third pressure plate disposed between the first pressure plate and the flexible envelope element; and
a second actuator unit disposed between the first pressure plate and the third pressure plate, wherein a distance between the first pressure plate and the third pressure plate is changeable by the second actuator unit.

18. The electrical energy storage device according to claim 17, wherein the second actuator unit has a toothed rack or a threaded spindle or a lever system or a toggle lever mechanism or a ramp mechanism.

19. The electrical energy storage device according to claim 17, wherein an actuator of the rolling element or the second actuator unit is self-locking or is configured such that active locking occurs in a de-energized state.

20. A method for operating an electrical energy storage device, wherein the electrical energy storage device comprises:
a cell stack which comprises a plurality of layers of battery cells disposed one above the other in a stacking direction;
a first pressure plate;
a second pressure plate;
wherein the cell stack is disposed between the first pressure plate and the second pressure plate; and
an actuator unit, wherein a distance between the first pressure plate and the second pressure plate is changeable by actuation of the actuator unit;
wherein the actuator unit has:
a flexible envelope element which encloses the first pressure plate, the second pressure plate, and the cell stack; and
a rolling element, wherein the flexible envelope element is rollable up and unrollable by the rolling element such that the distance between the first pressure plate and the second pressure plate is changeable by a change in a length of the flexible envelope element in a peripheral direction of the flexible envelope element;
and the method comprising the step of:
rolling up or unrolling the flexible envelope element by the rolling element such that the distance between the first pressure plate and the second pressure plate is changed by the change in the length of the flexible envelope element in the peripheral direction of the flexible envelope element.
